(19) United States
(12) Patent Application Publication
(10) Pub. No.: US 2015/0348319 A1
(43) Pub. Date: Dec. 3, 2015

(54) ADAPTIVE RE-MESHING FOR VIEW INTERPOLATION FROM IMAGES WITH DEPTH OR DISPARITY

(71) Applicants: ALEXEY M. SUPIKOV, San Jose, CA (US); MAHA EL CHOUBASSI, Santa Clara, CA (US); OSCAR NESTARES, San Jose, CA (US)

(72) Inventors: ALEXEY M. SUPIKOV, San Jose, CA (US); MAHA EL CHOUBASSI, Santa Clara, CA (US); OSCAR NESTARES, San Jose, CA (US)

(21) Appl. No.: 14/294,309

(22) Filed: Jun. 3, 2014

(51) Int. Cl. G06T 17/20; G06T 15/40; G06T 15/20

(52) U.S. Cl. CPC G06T 17/205; G06T 15/205; G06T 15/40

(57) ABSTRACT

Methods and systems may provide for creating a non-uniform mesh for a first image, the non-uniform mesh including a plurality of vertices that align with one or more boundaries in the first image. Additionally, sample data associated with at least the first image may be obtained, wherein the sample data corresponds to the plurality of vertices. In one example, a second image is synthesized based at least in part on the sample data, wherein synthesizing the second image includes rendering one or more areas that are un-occluded in the second image and are occluded in the first image.

### BACKGROUND

Image-based rendering applications such as virtual tours and/or “fly-through” simulations may capture images of a three-dimensional (3D) scene from various points of view and use the captured images to synthesize images that represent intermediate points of view of the 3D scene (e.g., “view interpolation”). Conventional approaches to view interpolation may involve sampling disparity and/or depth information from the captured images according to a uniform and relatively sparse mesh that maps sample locations onto pixels of the captured images. The sampled depth/disparity information may then be used to deform the captured images and render the synthesized images (e.g., by smoothly propagating depth/disparity information to all other image pixels using constrained optimization techniques). While such an approach may be suitable under certain circumstances, there remains considerable room for improvement.

For example, a number of noticeable artifacts may occur with respect to objects in the scene when the intermediate point of view changes dynamically. More particularly, sparse sampling, suboptimal sample placement and smooth propagation of depth/disparity values through object boundaries may result in incorrect deformations around object boundaries. Additionally, conventional continuity and smoothness assumptions may fail to take into account occlusions that occur between objects as the point of view changes. As a result, occluded regions of the scene may still be visible in the synthesized images (e.g., appearing to be merely shrunk in size) even though they would not be visible in an accurate representation of the intermediate point of view.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a non-uniform mesh mapped onto a captured image according to an embodiment;

FIG. 2 is an illustration of an example of a non-uniform mesh mapped onto a synthetic image according to an embodiment;

FIG. 3 is a flowchart of an example of a method of conducting view interpolation according to an embodiment;

FIG. 4 is an illustration of an example of an application of a distortion policy to a non-uniform mesh according to an embodiment;

FIGS. 5A and 5B are illustrations of examples of adaptive re-meshing solutions according to an embodiment;

FIG. 6 is a flowchart of an example of a method of creating a non-uniform mesh according to an embodiment;

FIG. 7 is a block diagram of an example of view interpolation logic according to an embodiment;

FIG. 8 is a block diagram of an example of a system having a navigation controller according to an embodiment; and

FIG. 9 is a block diagram of an example of a system having a small form factor according to an embodiment.

### DETAILED DESCRIPTION

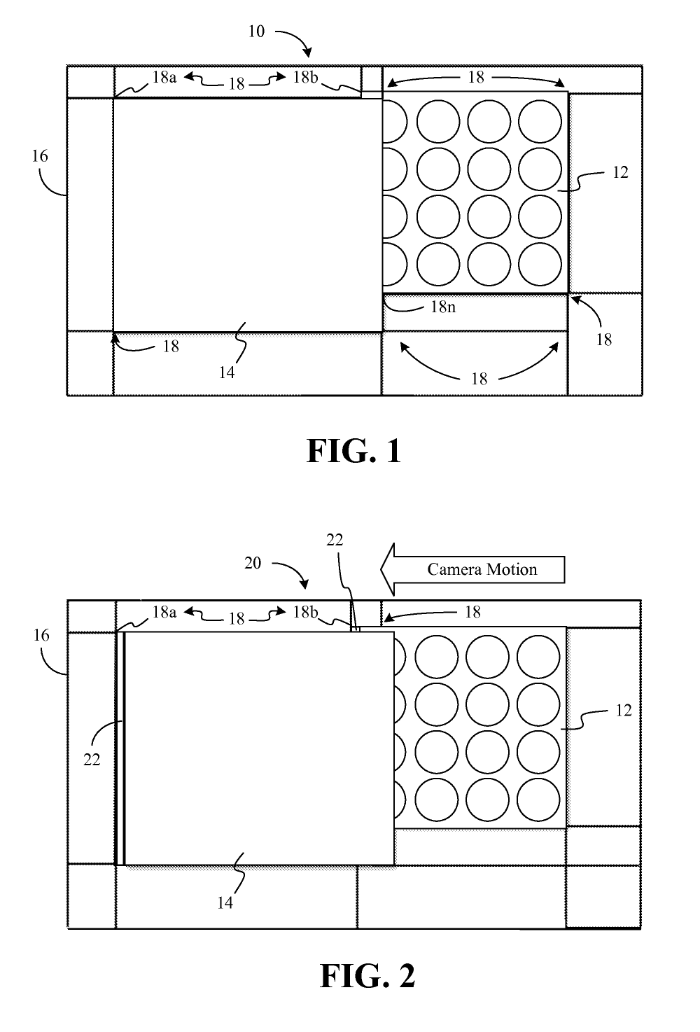

FIG. 1 shows a captured image 10 of a 3D scene containing a first object 12 that is partially obscured by a second object 14. The scene reflected in the captured image 10 might be rendered by an application such as, for example, a virtual tour, virtual reality game and/or fly-through simulator, wherein the captured image 10 is taken from a particular point of view (e.g., view angle) relative to the scene. The captured image 10 may either have depth information that facilitates the generation of intermediate views or be combined with other captured images to generate intermediate views. In the illustrated example, a non-uniform mesh 16 is mapped onto the captured image 10. The non-uniform mesh 16 may have horizontal and vertical edges that intersect at a plurality of vertices 18 (18a-18n) and form various polygons (e.g., rectangles). Moreover, the plurality of vertices 18 may align with one or more boundaries in the captured image 10.

For example, a first vertex 18a might align with a top left boundary of the second object 14, a second vertex 18b might align with a top left boundary of the first object 12, a third vertex 18n might align with a right boundary of the second object 14, and so forth. Boundaries may also result from a lack of image data in, for example, noisy image capture configurations. The vertices 18 may be used to sample data such as depth, color and/or disparity (e.g., relative to another captured image, not shown) from the captured image 10. As will be discussed in greater detail, the illustrated non-uniform mesh 16 enables the elimination of artifacts that may otherwise occur when the captured image 10 is used to synthesize another image having a point of view that differs from the point of view of the captured image 10. More particularly, aligning the vertices 18 of the non-uniform mesh 16 with the boundaries of the objects 12, 14 may enable the sample data to track object boundaries with high precision, which may in turn enable occlusions to be displayed correctly from other points of view.

In this regard, FIG. 2 shows a synthesized image 20 of the 3D scene containing the first object 12 and the second object 14, taken from a point of view that is slightly to the left of the point of view associated with the captured image 10 (FIG. 1). The synthesized image 20 may therefore represent the 3D scene at a subsequent moment in time as virtual camera motion transitions from right to left in an image-based rendering application. Accordingly, the vertices 18 of the mesh 16 may be shifted to account for that motion and accurately render the objects 12, 14 in the 3D scene.

In the illustrated example, the top left boundary of the second object 14, the top left boundary of the first object 12, the right boundary of the second object 14, and so forth, are not warped or otherwise distorted due to the samples being taken from regions near the boundaries of the objects 12, 14, rather than from arbitrary regions elsewhere in the captured image 10 (FIG. 1). Additionally, the circles of the first object 12 that are partially occluded by the second object 14 are not distorted in the illustrated example. Moreover, areas 22 in the 3D scene that were occluded in the captured image 10 (FIG. 1) and are un-occluded in the synthesized image 20 (e.g., due to the virtual camera motion) may be rendered correctly because the vertices 18 (e.g., and corresponding image samples) are tightly correlated to the boundaries of the objects 12, 14. The areas 22 may be rendered as polygons based on data from another captured image, a distortion policy that is applied to the non-uniform mesh 16, etc., or any combination thereof.

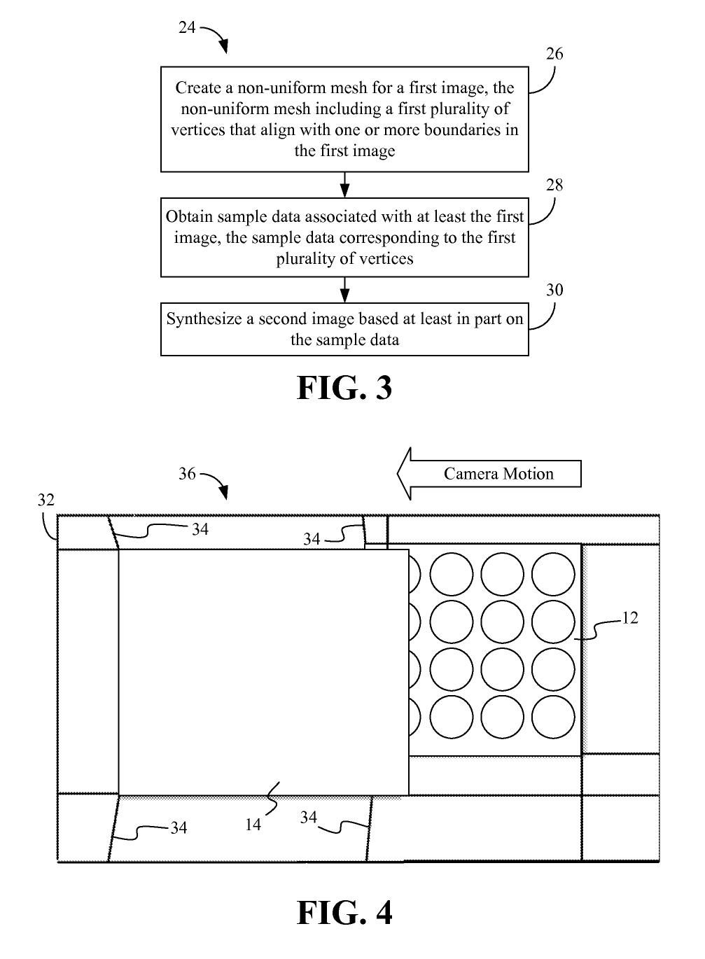

Turning now to FIG. 3, a method 24 of conducting view interpolation is shown. The method 24 may be implemented as one or more modules in executable software as a set of logic instructions stored in a machine- or computer-readable storage medium of a memory such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

Illustrated processing block 26 provides for creating a non-uniform mesh for a first image (e.g., a captured image), wherein the non-uniform mesh includes a plurality of vertices that align with one or more boundaries in the first image. As will be discussed in greater detail, block 26 may involve an iterative process that begins with a uniform mesh having a relatively fine resolution and ends with the non-uniform mesh that closely tracks the boundaries present in the captured image. Moreover, block 26 may be conducted offline (e.g., in the background, when captured images are initially loaded, etc.). Sample data associated with the first image may be obtained at block 28, wherein the sample data corresponds to the plurality of vertices. Block 28 may involve retrieving sample results from an appropriate memory location, register, network controller, etc., sampling the captured image, and so forth, or any combination thereof.

Illustrated block 30 synthesizes a second image (e.g., a synthesized image) based at least in part on the sample data. As already noted, the first image may be associated with a first point of view and the second image may be associated with a second point of view that differs from the first point of view. Moreover, block 30 may involve rendering one or more areas that are un-occluded in the second image and are occluded in the first image. The un-occluded areas may be rendered based on data from a third image (e.g., another captured image), a distortion policy that is applied to the non-uniform mesh, etc., or any combination thereof.

In this regard, FIG. 4 shows a scenario in which a distortion policy is applied to the non-uniform mesh 16 (FIG. 1) to obtain a modified mesh 32 having warped segments 34 that are outside the boundaries of the objects 12, 14, and therefore have minimal-to-no perceptible impact on the quality of a synthesized image 36 of the 3D scene. Alternatively, sample data from another captured image (e.g., polygon data stored in a Z-buffer and/or depth map, not shown) may be used to render the un-occluded areas.

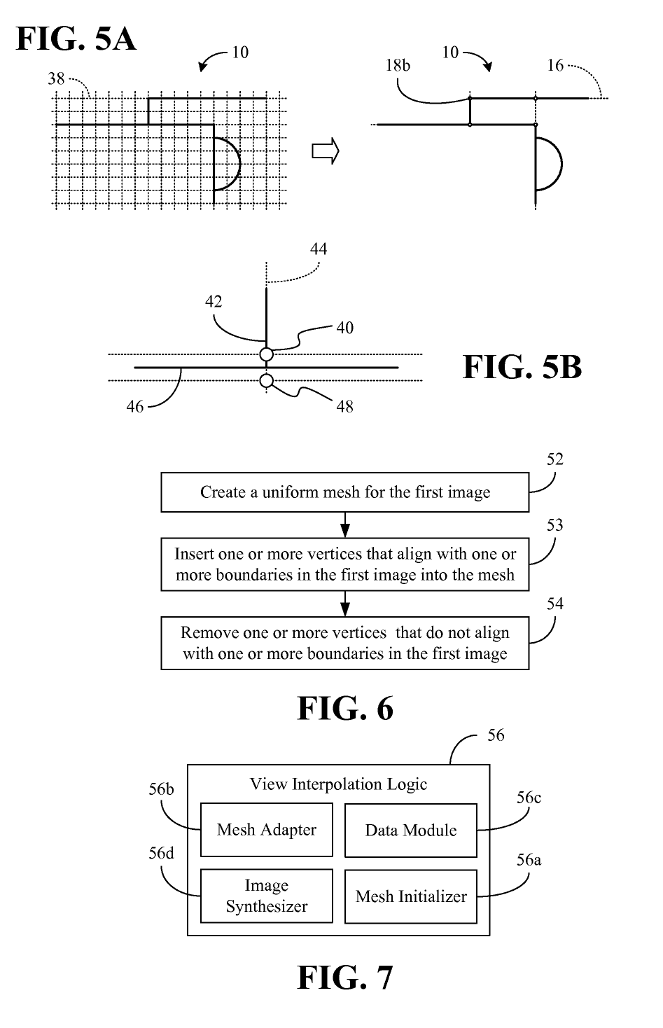

FIG. 5A demonstrates that a uniform mesh 38 having a relatively fine resolution (e.g., one vertex per pixel) may be created and mapped onto the captured image 10. In the illustrated example, the vertices of the uniform mesh 38 that do not align with one or more boundaries in the captured image 10 are removed to adaptively “re-mesh” the uniform mesh 38 and create the non-uniform mesh 16. More particularly, an edge/boundary mask may be created using a selected discontinuity measure function, wherein the edge/boundary mask may enable fast estimation of object boundary positions with sub-pixel precision. Thus, the uniform mesh 38 may be readily constructed and corresponding depth/disparity values may be assigned as an attribute to each vertex of the uniform mesh 38.

In one example, the adaptive re-meshing iteratively analyzes a uniform mesh by first inserting vertices on object boundaries and splitting the mesh along the boundary edges. The boundary vertices and edges may be marked as a boundary. When a new boundary vertex is inserted, it may be duplicated together with the newly inserted edges in order to create/extend a topological cut (e.g., a “hole”) in the mesh. The new boundary vertex may be assigned a depth/disparity value corresponding to its side of the boundary while the duplicated vertex is assigned a value corresponding to the other side of the boundary. In one example, the boundary vertex is created on each mesh edge that crosses an object boundary. A position for such a vertex may be computed as the intersection of the edge with the boundary.

Thus, FIG. 5B demonstrates that a new boundary vertex 40 and mesh edge 44 may be inserted on an object boundary 42 that intersects with another object boundary 46. The boundary vertex 40 may be duplicated as another vertex 48 on the other side of the object boundary 46. As a result, the sample corresponding to the boundary vertex 40 may obtain depth, disparity and/or color data from the object having the boundary 46, whereas the sample corresponding to the vertex 48 may obtain depth, disparity and/or color data from the object having the boundary 46.

The adaptive re-meshing may also remove unnecessary vertices in the areas of smooth and/or nearly planar scene geometry (e.g., close depth values, low discontinuity measure values, etc.), while preserving the structure of boundary edges. To preserve the structure of boundary edges, the removal of a boundary vertex may follow three guidelines:

Respecting the boundary—when an inner vertex is removed, the boundary vertices don't move.

Symmetrical boundary changes—the boundary vertex is removed together with its duplicate on the other side of the same boundary. The adjacent boundary vertices and/or edges and their duplicates may be transformed the same way.

Following boundaries—the boundary vertices shifted as a result of a boundary vertex removal shifts along the boundary.

Other approaches to removing vertices may be used, depending on the circumstances. Nevertheless, the vertex insertion/removal operations may be performed in a topology aware manner, producing a “manifold” mesh that tracks the object boundaries in the image. Moreover, the insertion/removal operations may be performed until particular criteria are met (e.g., polygon count or surface error threshold reached).

FIG. 6 shows a method 50 of creating a non-uniform mesh. The method 50 may therefore be readily substituted for processing block 26 (FIG. 3), already discussed. The method 50 may therefore be implemented as one or more modules in executable software as a set of logic instructions stored in a machine- or computer-readable storage medium of a memory such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof. A uniform mesh may be created for a first image at block 52, wherein illustrated block 53 inserts one or more vertices that align with one or more boundaries in the first image into the mesh and block 54 removes one or more vertices of the uniform mesh that do not align with one or more boundaries in the first image. In one example, block 54 involves removing the one or more vertices in accordance with criteria defining a polygon count, a surface error, etc., or any combination thereof. For example, the number of polygons in the mesh might be reduced (e.g., via vertex removal) until a maximum surface error threshold is reached. Such an approach may provide for an optimal number of vertices.

Turning now to FIG. 7, view interpolation logic 56 (56a-56d) is shown, wherein the illustrated view interpolation logic 56 may generally function as an apparatus configured to render synthesized images from intermediate points of view. More particularly, one or more aspects of the view interpolation logic 56 may be implemented as fixed functionality logic hardware. In the illustrated example, a mesh initializer 56a creates a uniform mesh for a first image and a mesh adapter 56b inserts one or more vertices aligned with one or more boundaries in the first image into the uniform mesh and removes one or more vertices of the mesh that do not align with one or more boundaries in the first image. As already noted, the one or more vertices may be removed in accordance with criteria defining one or more of a polygon count or a surface error. The removal may therefore result in a non-uniform mesh having a plurality of vertices that align with one or more boundaries in the first image.

The illustrated view interpolation logic 56 also includes a data module 56c to obtain sample data associated with at least the first image, wherein the sample data corresponds to the plurality of vertices. The data module 56c may retrieve sample results from an appropriate memory location, register, network controller, etc., sample the first image, and so forth, or any combination thereof. Additionally, an image synthesizer 56d may synthesize a second image based at least in part on the sample data. The first image may be associated with a first point of view and the second image may be associated with a second point of view that differs from the first point of view. In one example, the image synthesizer 56d renders one or more areas that are un-occluded in the second image and are occluded in the first image. Moreover, the one or more areas may be rendered based on one or more of data from a third image (e.g., another captured image) or a distortion policy that is applied to the non-uniform mesh.

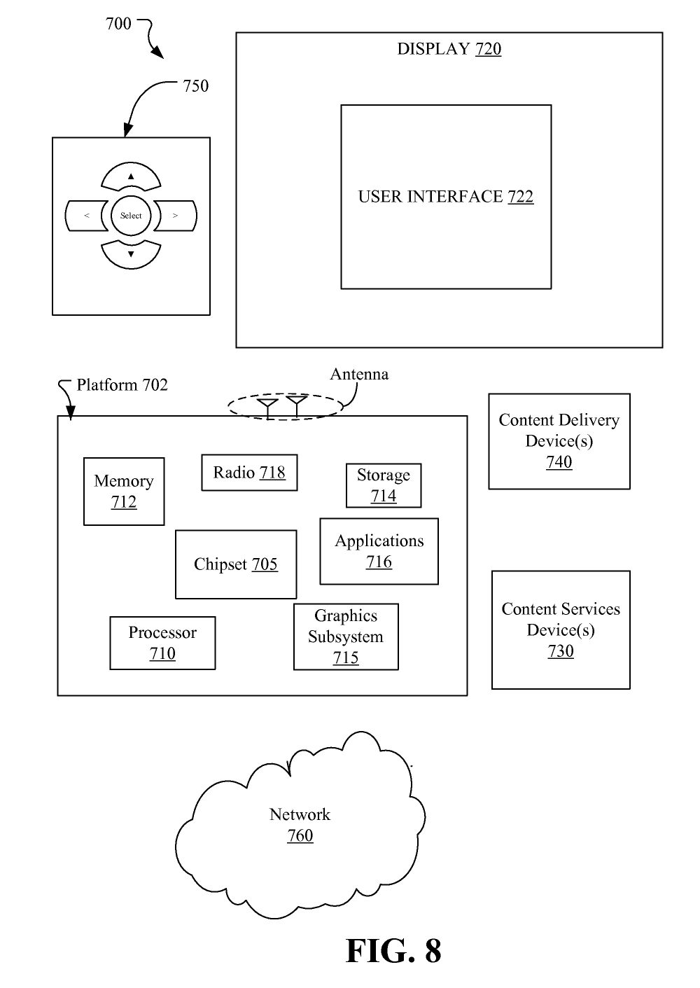

FIG. 8 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth. Thus, the system 700 may be used to conduct view interpolation as described herein.

In embodiments, the system 700 comprises a platform 702 coupled to a display 720 that presents visual content. The platform 702 may receive video bitstream content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, the platform 702 may comprise any combination of a chipset 705, processor 710, memory 712, storage 714, graphics subsystem 715, applications 716 and/or radio 718 (e.g., network controller). The chipset 705 may provide intercommunication among the processor 710, memory 712, storage 714, graphics subsystem 715, applications 716 and/or radio 718. For example, the chipset 705 may include a storage adapter (not depicted) capable of providing intercommunication with the storage 714.

The processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, the processor 710 may comprise dual-core processor(s), dual-core mobile processor(s), and so forth.

The memory 712 may be implemented as a volatile memory device such as, but not limited to, a Random Access Memory (RAM), Dynamic Random Access Memory (DRAM), or Static RAM (SRAM).

The storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

The graphics subsystem 715 may perform processing of images such as still or video for display. The graphics subsystem 715 may be a graphics processing unit (GPU) or a visual processing unit (VPU), for example. The graphics subsystem 715 may therefore include the view interpolation logic 56 (FIG. 7), already discussed. In addition, the processor 710 may be configured to operate via instructions obtained from the memory 712, the storage 714 or other suitable source. An analog or digital interface may be used to communicatively couple the graphics subsystem 715 and display 720. For example, the interface may be any of a High-Definition Multimedia Interface, DisplayPort, wireless HDMI, and/or wireless HD compliant techniques. The graphics subsystem 715 could be integrated into processor 710 or chipset 705. The graphics subsystem 715 could be a stand-alone card communicatively coupled to the chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 718 may be a network controller including one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, the display 720 may comprise any television type monitor or display. The display 720 may comprise, for example, a computer display screen, touch screen display, video monitor, television-like device, and/or a television. The display 720 may be digital and/or analog. In embodiments, the display 720 may be a holographic display. Also, the display 720 may be a transparent surface that may receive a visual projection. Such projections may convey various forms of information, images, and/or objects. For example, such projections may be a visual overlay for a mobile augmented reality (MAR) application. Under the control of one or more software applications 716, the platform 702 may display user interface 722 on the display 720.

In embodiments, content services device(s) 730 may be hosted by any national, international and/or independent service and thus accessible to the platform 702 via the Internet, for example. The content services device(s) 730 may be coupled to the platform 702 and/or to the display 720. The platform 702 and/or content services device(s) 730 may be coupled to a network 760 to communicate (e.g., send and/or receive) media information to and from network 760. The content delivery device(s) 740 also may be coupled to the platform 702 and/or to the display 720.

In embodiments, the content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

The content services device(s) 730 receives content such as cable television programming including media information, digital information, and/or other content. Examples of content providers may include any cable or satellite television or radio or Internet content providers. The provided examples are not meant to limit embodiments.

In embodiments, the platform 702 may receive control signals from a navigation controller 750 having one or more navigation features. The navigation features of the controller 750 may be used to interact with the user interface 722, for example. In embodiments, the navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of the controller 750 may be echoed on a display (e.g., display 720) by movements of a pointer, cursor, focus ring, or other visual indicators displayed on the display. For example, under the control of software applications 716, the navigation features located on the navigation controller 750 may be mapped to virtual navigation features displayed on the user interface 722, for example. In embodiments, the controller 750 may not be a separate component but integrated into the platform 702 and/or the display 720. Embodiments, however, are not limited to the elements or in the context shown or described herein.

In embodiments, drivers (not shown) may comprise technology to enable users to instantly turn on and off the platform 702 like a television with the touch of a button after initial boot-up, when enabled, for example. Program logic may allow the platform 702 to stream content to media adaptors or other content services device(s) 730 or content delivery device(s) 740 when the platform is turned “off.” In addition, chipset 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in the system 700 may be integrated. For example, the platform 702 and the content services device(s) 730 may be integrated, or the platform 702 and the content delivery device(s) 740 may be integrated, or the platform 702, the content services device(s) 730, and the content delivery device(s) 740 may be integrated, for example. In various embodiments, the platform 702 and the display 720 may be an integrated unit. The display 720 and content service device(s) 730 may be integrated, or the display 720 and the content delivery device(s) 740 may be integrated, for example. These examples are not meant to limit the embodiments.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

The platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 8.

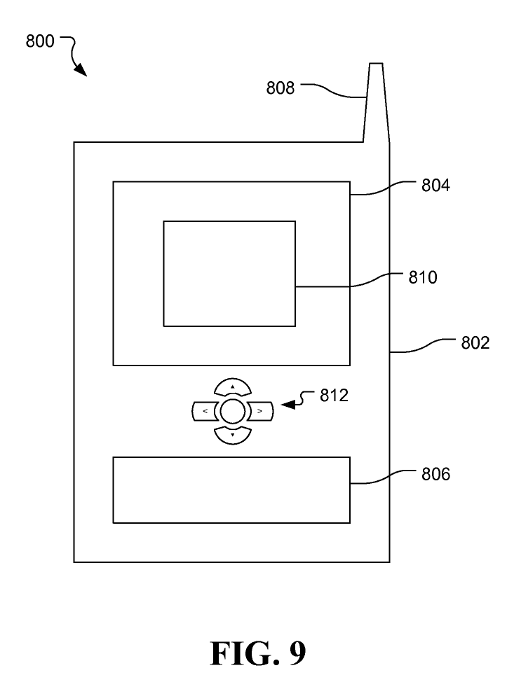

As described above, the system 700 may be embodied in varying physical styles or form factors. FIG. 9 illustrates embodiments of a small form factor device 800 in which the system 700 may be embodied. In embodiments, for example, the device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 9, the device 800 may comprise a housing 802, a display 804, an input/output (I/O) device 806, and an antenna 808. The device 800 also may comprise navigation features 812. The display 804 may comprise any suitable display unit for displaying information appropriate for a mobile computing device. The I/O device 806 may comprise any suitable I/O device for entering information into a mobile computing device. Examples for the I/O device 806 may include an alphanumeric keyboard, a numeric keypad, a touch pad, input keys, buttons, switches, rocker switches, microphones, speakers, voice recognition device and software, and so forth. Information also may be entered into the device 800 by way of microphone. Such information may be digitized by a voice recognition device. The embodiments are not limited in this context.

Additional Notes and Examples:

Example 1 may include a view interpolation system comprising a network controller to receive a first image and a mesh adapter to create a non-uniform mesh for the first image, the non-uniform mesh to include a plurality of vertices that align with one or more boundaries in the first image. The system may also comprise a data module to obtain sample data associated with at least the first image, the sample data to correspond to the plurality of vertices, and an image synthesizer to synthesize a second image based at least in part on the sample data.

Example 2 the system of Example 1, wherein the image synthesizer is to render one or more areas that are un-occluded in the second image and are occluded in the first image.

Example 3 may include the system of Example 2, wherein the one or more areas are to be rendered based on one or more of data from a third image or a distortion policy that is applied to the non-uniform mesh.

Example 4 may include the system of Example 1, further including a mesh initializer to create a uniform mesh for the first image, wherein the mesh adapter is to insert one or more vertices that align with one or more boundaries in the first image into the uniform mesh and to remove one or more vertices that do not align with one or more boundaries in the first image.

Example 5 may include the system of Example 4, wherein the one or more vertices are to be removed in accordance with criteria defining one or more of a polygon count or a surface error.

Example 6 may include the system of any one of Examples 1 to 5, wherein the first image is to be associated with a first point of view and the second image is to be associated with a second point of view that differs from the first point of view.

Example 7 may include a method of interpolating views, comprising creating a non-uniform mesh for a first image, the non-uniform mesh including a plurality of vertices that align with one or more boundaries in the first image, obtaining sample data associated with at least the first image, the sample data corresponding to the plurality of vertices, and synthesizing a second image based at least in part on the sample data.

Example 8 may include the method of Example 7, wherein synthesizing the second image includes rendering one or more areas that are un-occluded in the second image and are occluded in the first image.

Example 9 may include the method of Example 8, wherein the one or more areas are rendered based on one or more of data from a third image or a distortion policy that is applied to the non-uniform mesh.

Example 10 may include the method of Example 7, wherein creating the non-uniform mesh includes creating a uniform mesh for the first image; inserting one or more vertices that align with one or more boundaries in the first image into the uniform mesh; and removing one or more vertices that do not align with one or more boundaries in the first image.

Example 11 may include the method of Example 10, wherein the one or more vertices of the uniform mesh are removed in accordance with criteria defining one or more of a polygon count or a surface error.

Example 12 may include the method of any one of Examples 7 to 11, wherein the first image is associated with a first point of view and the second image is associated with a second point of view that differs from the first point of view.

Example 13 may include at least one computer readable storage medium comprising a set of instructions which, when executed by a computing device, cause the computing device to create a non-uniform mesh for a first image, the non-uniform mesh to include a plurality of vertices that align with one or more boundaries in the first image, obtain sample data associated with at least the first image, the sample data to correspond to the plurality of vertices, and synthesize a second image based at least in part on the sample data.

Example 14 may include the at least one computer readable storage medium of Example 13, wherein the instructions, when executed, cause a computing device to render one or more areas that are un-occluded in the second image and are occluded in the first image.

Example 15 may include the at least one computer readable storage medium of Example 14, wherein the one or more areas are to be rendered based on one or more of data from a third image or a distortion policy that is applied to the non-uniform mesh.

Example 16 may include the at least one computer readable storage medium of Example 13, wherein the instructions, when executed, cause a computing device to create a uniform mesh for the first image; insert one or more vertices that align with one or more boundaries in the first image into the uniform mesh; and remove one or more vertices that do not align with one or more boundaries in the first image.

Example 17 may include the at least one computer readable storage medium of Example 16, wherein the one or more vertices are to be removed in accordance with criteria defining one or more of a polygon count or a surface error.

Example 18 may include the at least one computer readable storage medium of any one of Examples 13 to 17, wherein the first image is to be associated with a first point of view and the second image is to be associated with a second point of view that differs from the first point of view.

Example 19 may include a view interpolation apparatus comprising a mesh adapter to create a non-uniform mesh for a first image, the non-uniform mesh to include a plurality of vertices that align with one or more boundaries in the first image, a data module to obtain sample data associated with at least the first image, the sample data to correspond to the plurality of vertices, and an image synthesizer to synthesize a second image based at least in part on the sample data.

Example 20 may include the apparatus of Example 19, wherein the image synthesizer is to render one or more areas that are un-occluded in the second image and are occluded in the first image.

Example 21 may include the apparatus of Example 20, wherein the one or more areas are to be rendered based on one or more of data from a third image or a distortion policy that is applied to the non-uniform mesh.

Example 22 may include the apparatus of Example 19, further including a mesh initializer to create a uniform mesh for the first image, wherein the mesh adapter is to insert one or more vertices that align with one or more boundaries in the first image into the uniform mesh and to remove one or more vertices that do not align with one or more boundaries in the first image.

Example 23 may include the apparatus of Example 22, wherein the one or more vertices are to be removed in accordance with criteria defining one or more of a polygon count or a surface error.

Example 24 may include the apparatus of any one of Examples 19 to 23, wherein the first image is to be associated with a first point of view and the second image is to be associated with a second point of view that differs from the first point of view.

Example 25 may include a view interpolation apparatus comprising means for performing the method of any one of Examples 7 to 12.

Techniques may therefore produce visually correct results everywhere in a synthesized image, including around object boundaries. Moreover, occlusions may be displayed directly and the high quality visual results may be achieved at the optimal computation load since the number and positions of samples are close to optimal. Additionally, detecting and displacing object boundaries with high precision enables information from multiple views to be fused without full reconstruction of a 3D model (e.g., leading to further improvement of image quality and/or extending the ranges of virtual camera positions/orientations for the synthesized view). Supporting two depth/disparity values on the same boundary enables correct displaying of occlusions and detection of areas to be filled by the color values from other views. In addition, techniques may use disparity/depth to understand scene structure.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments of this have been described in connection with particular examples thereof, the true scope of the embodiments should not be so limited since other modifications will become apparent to the skilled practitioner upon a study of the drawings, specification, and following claims.

We claim:

1. A system comprising:
a network controller to receive a first image;
a mesh adapter to create a non-uniform mesh for the first image, the non-uniform mesh to include a plurality of vertices that align with one or more boundaries in the first image;
a data module to obtain sample data associated with at least the first image, the sample data to correspond to the plurality of vertices; and
an image synthesizer to synthesize a second image based at least in part on the sample data.

2. The system of claim 1, wherein the image synthesizer is to render one or more areas that are un-occluded in the second image and are occluded in the first image.

3. The system of claim 2, wherein the one or more areas are to be rendered based on one or more of data from a third image or a distortion policy that is applied to the non-uniform mesh.

4. The system of claim 1, further including a mesh initializer to create a uniform mesh for the first image, wherein the mesh adapter is to insert one or more vertices that align with one or more boundaries in the first image into the uniform mesh and to remove one or more vertices that do not align with one or more boundaries in the first image.

5. The system of claim 4, wherein the one or more vertices are to be removed in accordance with criteria defining one or more of a polygon count or a surface error.

6. The system of claim 1, wherein the first image is to be associated with a first point of view and the second image is to be associated with a second point of view that differs from the first point of view.

7. A method comprising:
creating a non-uniform mesh for a first image, the non-uniform mesh including a plurality of vertices that align with one or more boundaries in the first image;
obtaining sample data associated with at least the first image, the sample data corresponding to the plurality of vertices; and
synthesizing a second image based at least in part on the sample data.

8. The method of claim 7, wherein synthesizing the second image includes rendering one or more areas that are un-occluded in the second image and are occluded in the first image.

9. The method of claim 8, wherein the one or more areas are rendered based on one or more of data from a third image or a distortion policy that is applied to the non-uniform mesh.

10. The method of claim 7, wherein creating the non-uniform mesh includes:
creating a uniform mesh for the first image;
inserting one or more vertices that align with one or more boundaries in the first image into the mesh; and
removing one or more vertices that do not align with one or more boundaries in the first image.

11. The method of claim 10, wherein the one or more vertices of the uniform mesh are removed in accordance with criteria defining one or more of a polygon count or a surface error.

12. The method of claim 7, wherein the first image is associated with a first point of view and the second image is associated with a second point of view that differs from the first point of view.

13. At least one computer readable storage medium comprising a set of instructions which, when executed by a computing device, cause the computing device to:
create a non-uniform mesh for a first image, the non-uniform mesh to include a plurality of vertices that align with one or more boundaries in the first image;
obtain sample data associated with at least the first image, the sample data to correspond to the plurality of vertices; and
synthesize a second image based at least in part on the sample data.

14. The at least one computer readable storage medium of claim 13, wherein the instructions, when executed, cause a computing device to render one or more areas that are un-occluded in the second image and are occluded in the first image.

15. The at least one computer readable storage medium of claim 14, wherein the one or more areas are to be rendered based on one or more of data from a third image or a distortion policy that is applied to the non-uniform mesh.

16. The at least one computer readable storage medium of claim 13, wherein the instructions, when executed, cause a computing device to:
create a uniform mesh for the first image;
insert one or more vertices that align with one or more boundaries in the first image into the uniform mesh; and
remove one or more vertices that do not align with one or more boundaries in the first image.

17. The at least one computer readable storage medium of claim 16, wherein the one or more vertices are to be removed in accordance with criteria defining one or more of a polygon count or a surface error.

18. The at least one computer readable storage medium of claim 13, wherein the first image is to be associated with a first point of view and the second image is to be associated with a second point of view that differs from the first point of view.

19. An apparatus comprising:
a mesh adapter to create a non-uniform mesh for a first image, the non-uniform mesh to include a plurality of vertices that align with one or more boundaries in the first image;
a data module to obtain sample data associated with at least the first image, the sample data to correspond to the plurality of vertices; and
an image synthesizer to synthesize a second image based at least in part on the sample data.

20. The apparatus of claim 19, wherein the image synthesizer is to render one or more areas that are un-occluded in the second image and are occluded in the first image.

21. The apparatus of claim 20, wherein the one or more areas are to be rendered based on one or more of data from a third image or a distortion policy that is applied to the non-uniform mesh.

22. The apparatus of claim 19, further including a mesh initializer to create a uniform mesh for the first image, wherein the mesh adapter is to insert one or more vertices that align with one or more boundaries in the first image into the mesh and to remove one or more vertices that do not align with one or more boundaries in the first image.

23. The apparatus of claim 22, wherein the one or more vertices are to be removed in accordance with criteria defining one or more of a polygon count or a surface error.

24. The apparatus of claim 19, wherein the first image is to be associated with a first point of view and the second image is to be associated with a second point of view that differs from the first point of view.
